(19) United States
(12) Patent Application Publication
(10) Pub. No.: US 2024/0428762 A1
(43) Pub. Date: Dec. 26, 2024

(54) LID MEMBER AND KEYBOARD INSTRUMENT

(71) Applicant: CASIO COMPUTER CO., LTD., Tokyo (JP)

(72) Inventors: Yuuki NAKAJIMA, Tokyo (JP); Shingo FUKUSHIMA, Tokyo (JP)

(21) Appl. No.: 18/752,967

(22) Filed: Jun. 25, 2024

(30) Foreign Application Priority Data
Jun. 26, 2023 (JP) 2023-104042

(51) Int. Cl. G10H 1/34

(52) U.S. Cl. CPC G10H 1/34; G10H 2220/221

(57) ABSTRACT

A lid member including a first member which is arranged on a front side of an opening portion of a case in a manner to be movable in front and back directions of the case, a second member which is arranged on a back side of the opening portion of the case in a manner to be movable in the front and back directions, a connection member which foldably connects the front member and the second member with each other, and an inelastic reinforcement member which is arranged between the front member and the second member.

### CROSS-REFERENCE TO RELATED APPLICATION

This application is based upon and claims the benefit of priority from the prior Japanese Patent Application No. 2023-104042, filed Jun. 26, 2023, the entire contents of which are incorporated herein by reference.

### BACKGROUND

### 1. Technical Field

The present disclosure relates to a lid member for keyboard instruments, audio devices, and the like, and a keyboard instrument equipped with the lid member.

### 2. Description of the Related Art

For example, a keyboard instrument is known which has a structure where a keyboard unit arranged in an instrument case is exposed from an opening section of the instrument case, and a keyboard lid openably and closably covers the keyboard unit by closing the opening section of the instrument case, as shown in Japanese Utility-Model Application Laid-Open (Kokai) Publication No. 57-30787.

### SUMMARY

An embodiment of the present disclosure is a lid member comprising: a first member which is arranged on a front side of an opening portion of a case in a manner to be movable in front and back directions of the case; a second member which is arranged on a back side of the opening portion of the case in a manner to be movable in the front and back directions; a connection member which foldably connects the front member and the second member with each other; and an inelastic reinforcement member which is arranged between the front member and the second member.

### BRIEF DESCRIPTION OF THE DRAWINGS

FIG. 1 is an external appearance perspective view showing an embodiment where the present disclosure has been applied in a keyboard instrument, in which a keyboard lid has been closed;

FIG. 2 is an external appearance perspective view showing the keyboard instrument of FIG. 1, in which the keyboard lid has been opened;

FIG. 3 is an enlarged cross-sectional view showing the keyboard instrument taken along the A-A arrow view in FIG. 1;

FIG. 4 is an enlarged cross-sectional view showing the keyboard instrument taken along the B-B arrow view in FIG. 2;

FIG. 5 is an enlarged back view showing part of the keyboard lid of the keyboard instrument shown in FIG. 1; and

FIG. 6 is an enlarged cross-sectional view showing the keyboard lid inverted and taken along the C-C arrow view in FIG. 5.

### DETAILED DESCRIPTION OF THE PREFERRED EMBODIMENTS

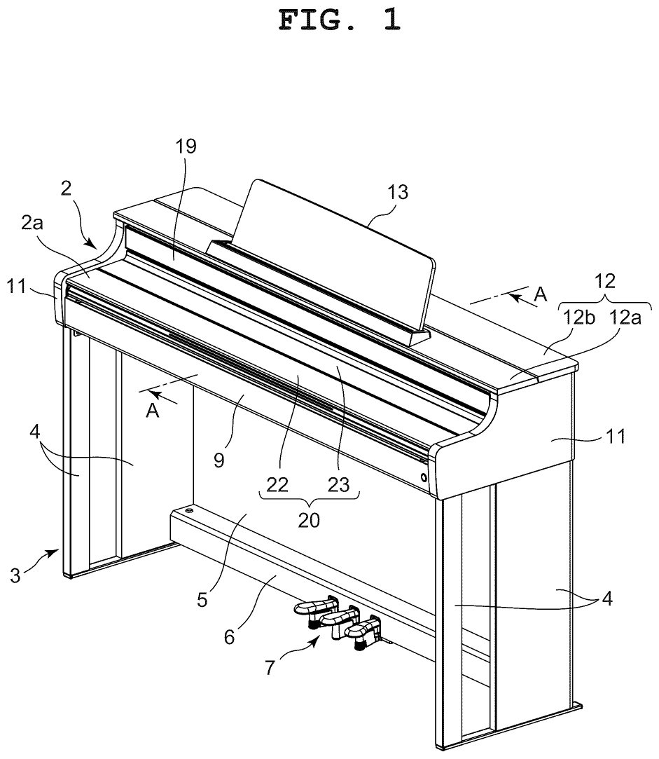

An embodiment where the present disclosure has been applied in a keyboard instrument will hereinafter be described with reference to FIG. 1 to FIG. 6.

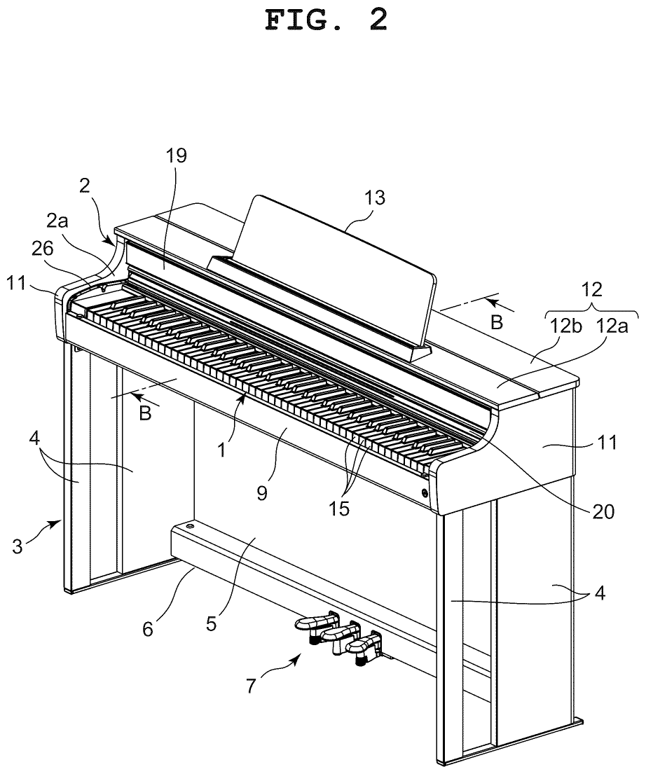

This keyboard instrument includes an instrument case 2 where a keyboard unit 1 is mounted, and a stand 3 which supports the instrument case 2, as shown in FIG. 1 and FIG. 2. The instrument case 2 has a horizontally long box shape whose upper front portion corresponding to the keyboard unit 1 is open.

The stand 3 includes a pair of supporting legs 4 which supports the sides of the undersurface of the instrument case 2 in a horizontal direction, a backboard 5 which is provided between the back ends of these supporting legs 4 and supports a back portion of the undersurface of the instrument case 2, and a pedal supporting plate 6 which is positioned on the lower part of the backboard 5 while extending between the lower parts of the pair of supporting legs 4, as shown in FIG. 1 and FIG. 2. In the present embodiment, on a middle portion of the pedal supporting plate 6 in the horizontal direction (longitudinal direction), a plurality of foot pedals 7 is provided.

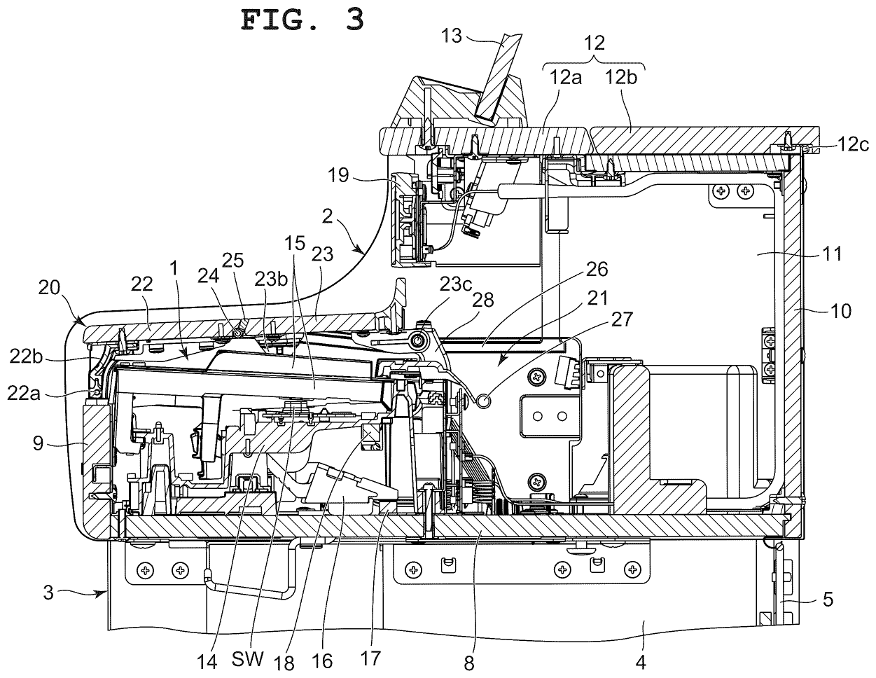

The instrument case 2 includes a bottom plate 8 having a batten plate shape which is long in the horizontal direction, a front plate 9 which is provided upright on the front end (left end in FIG. 3) of the bottom plate 8, a back plate 10 which is provided upright on the back end (right end in FIG. 3) of the bottom plate 8, a pair of side plates 11 which is provided upright on the sides (sides in the longitudinal direction in FIG. 1) of the bottom plate 8 in the horizontal direction, and a top plate 12 which is arranged on the upper parts of the pair of side plates 11 and the back plate 10, as shown in FIG. 1 to FIG. 4.

The front plate 9 is formed such that its height is equal to or less than the half of the height of the back plate 10, or more specifically, its height is about one-third of the height of the back plate 10, as shown in FIG. 1 to FIG. 4. Also, each side plate 11 is formed such that the height of a portion extending from its front end (left end in FIG. 3) to its substantially middle portion in the front to back direction (left to right direction in FIG. 3) is about half the height of the back plate 10. In addition, each side plate 11 is formed such that the height of a portion extending from its substantially middle portion to its back end (right end in FIG. 3) in the front to back direction (left to right direction in FIG. 3) is equal to the height of the back plate 10.

The top plate 12 is arranged on the upper end of the back plate 10 while being spanned across the upper ends of the back parts of the pair of side plates 11, as shown in FIG. 1 to FIG. 4. This top plate 12 includes a front side top plate 12a and a back side top plate 12b. The front side top plate 12a is fixed on the pair of side plates 11. On this front side top plate 12a, a music stand 13 is provided. Also, the back side top plate 12b is attached to the upper end of the back plate 10 in a manner to be rotatable by hinges 12c, whereby the back side of the instrument case 2 can be opened or closed.

The instrument case 2 has the keyboard unit 1 arranged between the front sides of the pair of side plates 11, as shown in FIG. 1 to FIG. 4. In this instrument case 2, an opening section 2a which exposes the keyboard unit 1 upward is formed. The keyboard unit 1 includes a keyboard chassis 14 arranged on the bottom plate 8 of the instrument case 2, a plurality of keys 15 parallelly arranged on the keyboard chassis 14 in a manner to be rotatable in vertical directions, and a plurality of hammer members 16 which applies action loads to the plurality of keys 15 by rotating in response to key depression operations performed on the plurality of keys 15.

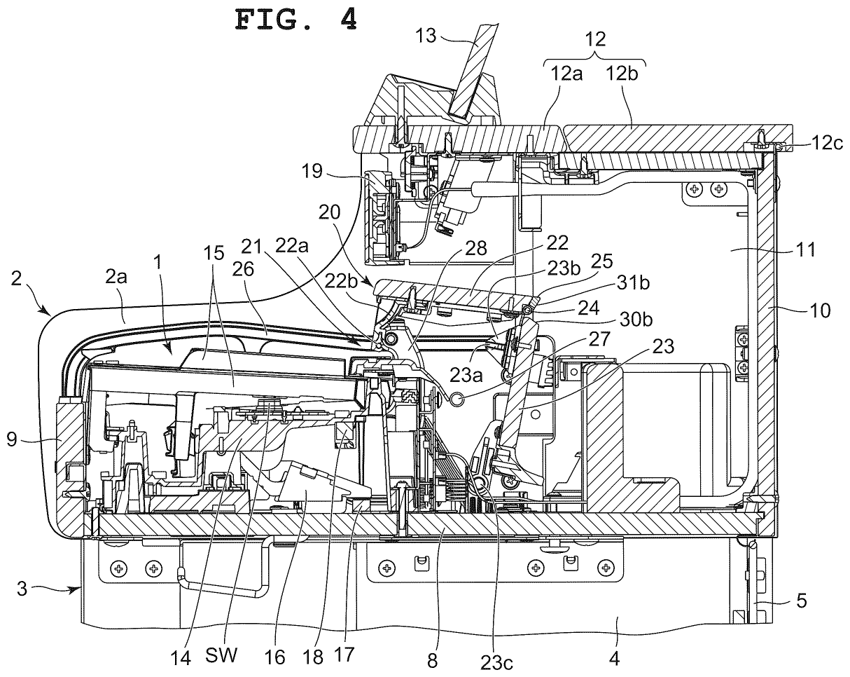

In the present embodiment, the hammer members 16 in an initial state where no key depression operation has been performed on the keys 15 are in contact with a lower limit stopper 17 which is provided on a portion of the bottom plate 8 of the instrument case 2 located in a lower area behind the keyboard chassis 14 and presses the keys 15 upward, as shown in FIG. 3 and FIG. 4. Also, each hammer member 16 rotated in response to a key depression operation performed on the corresponding key 15 comes in contact with an upper limit stopper 18 provided on the undersurface of a back portion of the keyboard chassis 14 located above the bottom plate 8 of the instrument case 2, and thereby limits the lower position of the pressed key 15.

In the case of this keyboard unit 1, the plurality of keys 15 is subjected to key depression operations while being upwardly exposed from the opening section 2a of the instrument case 2, as shown in FIG. 3 and FIG. 4. Also, in the case of this keyboard unit 1, when the plurality of keys 15 is subjected to key depression operations, switch sections SW provided on the keyboard chassis 14 perform switching operations and thereby output switch signals. In the present embodiment, in the instrument case 2, a console panel 19 is provided in an upper area behind the keyboard unit 1 toward the back side.

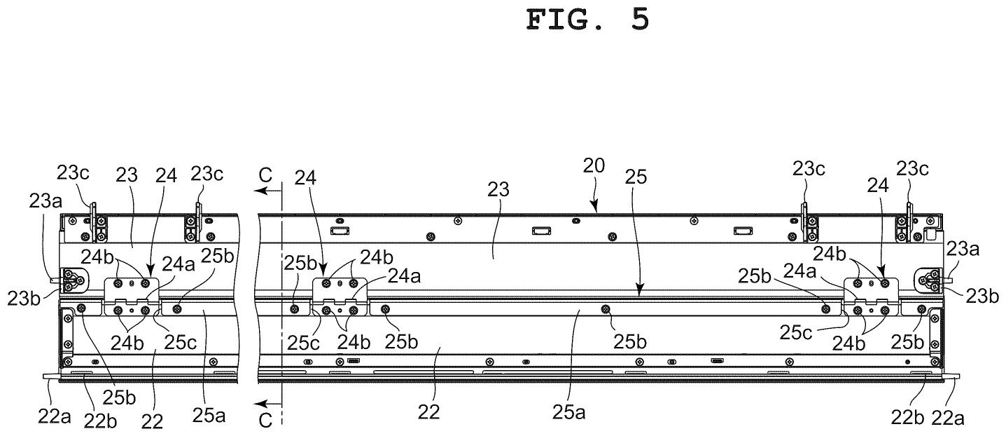

On the other hand, on the instrument case 2, a keyboard lid 20 which covers the upper side of the keyboard unit 1 is provided in a manner to be openable and closable by lid guide sections 21 provided in the instrument case 2, as shown in FIG. 1 to FIG. 4. This keyboard lid 20 includes a front lid 22 which is a first member that is long in the horizontal direction, and a back lid 23 which is a second member that is also long in the horizontal direction. These front and back lids 22 and 23 are foldably connected by a plurality of connection members 24, and a decorative reinforcement member 25 is provided between these front and back lids 22 and 23, as shown in FIG. 5.

On the right and left sides of a front end portion of the front lid 22, front guide shafts 22a which project toward the inner surfaces of the pair of side plates 11, respectively, are provided via front supporting legs 22b, as shown in FIG. 3 to FIG. 6. Also, on the right and left sides of a front end portion of the back lid 23, back guide shafts 23a which project toward the inner surfaces of the pair of side plates 11, respectively, are provided via back supporting legs 23b. On back end portions of this back lid 23, a plurality of arm connection sections 23c are provided which projects toward a back area inside the instrument case 2.

The lid guide sections 21 in the instrument case 2 guide such that, when the keyboard lid 20 covers the upper side of the keyboard unit 1, the front lid 22 and the back lid 23 are arranged side by side in a substantially flat plate shape, as shown in FIG. 3 and FIG. 4. Also, these lid guide sections 21 guide such that, when the keyboard lid 20 is to be housed in the back side of the instrument case 2 so as to expose the keyboard unit 1 upward, the front and back lids 22 and 23 are folded at the connection members 24, the front lid 22 is arranged under the front side top plate 12a of the top plate 12, and the back lid 23 hangs down near the back end of the keyboard unit 1.

More specifically, each lid guide section 21 includes a guide rail section 26 and a guide arm section (not shown in the drawings), as shown in FIG. 3 and FIG. 4. The guide rail section 26 is formed in the inner surface of the corresponding side plate 11 while extending from a portion immediately above the front plate 9 to a portion corresponding to an area under the back end of the front side top plate 12a of the top plate 12, that is, an area under the front end of the back side top plate 12b. This guide rail section 26 guides the corresponding front guide shaft 22a of the front lid 22 of the keyboard lid 20 and the corresponding back guide shaft 23a of the back lid 23.

By this guide rail section 26, when the front lid 22 and the back lid 23 cover the upper side of the keyboard unit 1, the corresponding front guide shaft 22a of the front lid 22 is held at the front end of the guide rail section 26, and the corresponding back guide shaft 23a of the back lid 23 is held at a portion of the guide rail section 26 corresponding to a substantially middle portion of the keyboard unit 1 in a front-back direction, as shown in FIG. 3 and FIG. 4. As a result, the front lid 22 and the back lid 23 are arranged side by side in the flat plate shape.

Also, by this guide rail section 26, when the keyboard lid 20 is housed in the back side of the instrument case 2 so that the keyboard unit 1 is exposed upward, the corresponding front guide shaft 22a of the front lid 22 is held at a portion of the guide rail section 26 corresponding to the front end of the top plate 12, that is, the front end of the front side top plate 12a, and the corresponding back guide shaft 23a of the back lid 23 is held at the back end of the guide rail section 26 corresponding to an area under the front end of the back side top plate 12b, as shown in FIG. 3 and FIG. 4.

As a result, this guide rail section 26 is structured such that, when the keyboard lid 20 is housed in the back side of the instrument case 2 so that the keyboard unit 1 is exposed upward, the front lid 22 is arranged under the front side top plate 12a of the top plate 12, and the back lid 23 is folded with respect to the front lid 22 at the connection members 24 such that the back lid 23 hangs down near the back end of the keyboard unit 1, as shown in FIG. 3 and FIG. 4.

When the back lid 23 is approaching the back end of the keyboard unit 1 so as to hang down, the arm connection sections 23c provided on the back end portions of the back lid 23 are guided by the guide arm sections (not shown in the drawings) so as to approach the back end of the keyboard unit 1 and hang down, as shown in FIG. 3 and FIG. 4. That is, each guide arm section is structured such that its one end is rotatably attached to the corresponding arm connection section 23c of the back lid 23 and its other end is rotatably attached to an arm supporting section 27 provided on the back end of the keyboard chassis 14. Each guide arm section can also be structured such that its one end is rotatably attached to the corresponding arm connection section 23c of the back lid 23 and its other end is rotatably attached to one of the pair of side plates 11.

Accordingly, the back lid 23 is structured such that the guide arm sections (not shown in the drawings) are vertically rotated and the arm connection sections 23c on the back end portions of the back lid 23 are vertically moved, whereby the back end of the back lid 23 is vertically moved between an upper position located at a substantially same height as the guide rail section 26 and a lower position located behind the keyboard unit 1, as shown in FIG. 3 and FIG. 4.

As a result, the lid guide sections 21 guide such that, when the front lid 22 and back lid 23 of the keyboard lid 20 are to cover the upper side of the keyboard unit 1 and thereby close the opening section 2a of the instrument case 2, the guide arm sections (not shown in the drawings) are rotated in a counterclockwise direction, and the arm connection sections 23c provided on the back end portions of the back lid 23 are lifted to be at a substantially same height as the guide rail section 26 and held by a holding section 28 provided on the upper part of the keyboard chassis 14, whereby the front lid 22 and the back lid 23 are arranged side by side in the flat plate shape, as shown in FIG. 3. The arm connection sections 23c can also be fixed to the back lid 23 without being held by the holding section 28.

Also, the lid guide sections 21 guide such that, when the keyboard lid 20 is to be housed in the back side of the instrument case 2 so that the keyboard unit 1 is exposed upward, the guide arm sections (not shown in the drawings) are rotated in a clockwise direction and downwardly inclined toward the back side, whereby the front and back lids 22 and 23 are housed in the instrument case 2 with them being folded, as shown in FIG. 4.

To the keyboard lid 20, the plurality of connection members 24 which foldably connects the front lid 22 and the back lid 23 to each other is attached across the undersurface of the front lid 22 and the undersurface of the back lid 23 by a plurality of screws 24b, as shown in FIG. 5. These connection members 24 are hinges and provided on three portions, or more specifically, side portions of the front lid 22 and the back lid 23 in a longitudinal direction and a middle portion thereof with connecting rotation sections 24a of the connection members 24 being arranged between the front lid 22 and the back lid 23.

Also, in the entire area between the front lid 22 and the back lids 23, a reinforcement member 25 which is decorative and inelastic is arranged, as shown in FIG. 3 to FIG. 6. This reinforcement member 25 is formed in a square bar shape by using a highly rigid metal, and decorated in the color of gold, silver, or the like. On this reinforcement member 25, a reinforcement attachment section 25a is provided which is an attachment section to be attached to the undersurface of the back part of the front lid 22.

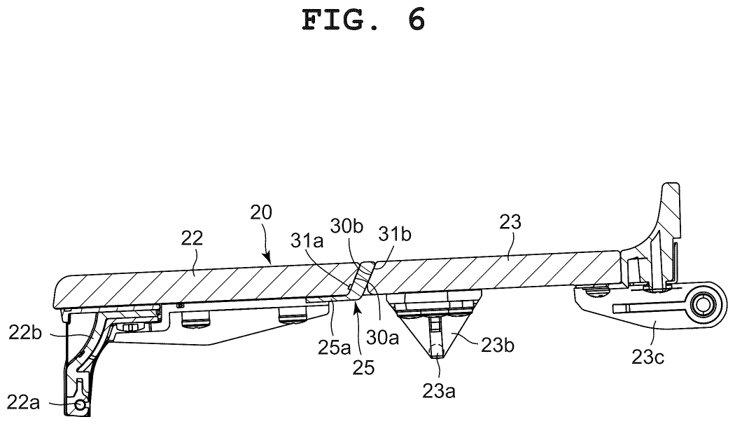

This reinforcement attachment section 25a is attached to the undersurface of the back side of the front lid 22 by a plurality of screws 25b, as shown in FIG. 5 and FIG. 6. In this reinforcement attachment section 25a, cutout sections 25c corresponding to the plurality of connection members 24 on the undersurface of the back side of the front lid 22 are provided. As a result, the reinforcement attachment section 25a is attached to the undersurface of the back side of the front lid 22 with the plurality of connection members 24 corresponding to the cutout sections 25c.

The back end surface of the front lid 22 and the front end surface of the back lid 23, which are the opposing surfaces of the front lid 22 and the back lid 23 that oppose each other, are formed to be lid inclined surfaces 30a and 30b which are first inclined surfaces inclined such that their upper parts are located closer to the back side of the instrument case 2 than their lower parts, as shown in FIG. 6. In addition, the front and back surfaces of the reinforcement member 25 are formed to be reinforcement inclined surfaces 31a and 31b which are second inclined surfaces inclined at angles equal to those of the lid inclined surfaces 30a and 30b formed by the back end surface of the front lid 22 and the front end surface of the back lid 23. As a result, the cross-sectional shape of the reinforcement member 25 is a substantially parallelogram.

Accordingly, in the case of this reinforcement member 25, when the front lid 22 and the back lid 23 are arranged side by side in the flat plate shape and close the opening section 2a of the instrument case 2 so as to cover the upper part of the keyboard unit 1, the lid inclined surface 30a on the back end side of the front lid 22 and the reinforcement inclined surface 31a on the front side of the reinforcement member 25 correspond to and come in close contact with each other, and the lid inclined surface 30b on the front end side of the back lid 23 and the reinforcement inclined surface 31b on the back side of the reinforcement member 25 correspond to and come in close contact with each other, as shown in FIG. 1, FIG. 3, and FIG. 6.

As a result of this structure where the lid inclined surface 30a on the back end surface of the front lid 22 and the reinforcement inclined surface 31a on the front surface of the reinforcement member 25 correspond to and come in close contact with each other and the lid inclined surface 30b on the front end surface of the back lid 23 and the reinforcement inclined surface 31b on the back surface of the reinforcement member 25 correspond to and come in close contact with each other, since the reinforcement inclined surfaces 31a and 31b of the reinforcement member 25, that is, the cross-sectional shape of the reinforcement member 25 is a substantially parallelogram, the reinforcement member 25 unfailingly receives loads applied to the front lid 22 and the back lid 23 and favorably hold the front lid 22 and the back lid 23, as shown in FIG. 1, FIG. 3, and FIG. 6.

Also, in the case of this reinforcement member 25, when the back lid 23 is folded with respect to the front lid 22 at the plurality of connection members 24 so that the front lid 22 and the back lid 23 are housed in the back side of the instrument case 2, the lid inclined surface 30b on the front end side of the back lid 23 is gradually separated from the reinforcement inclined surface 31b on the back side of the reinforcement member 25 toward the back side of the instrument case 2 with the reinforcement inclined surface 31a on the front side of the reinforcement member 25 and the lid inclined surface 30a on the back end side of the front lid 22 being in close contact with each other, as shown in FIG. 4.

Accordingly, in the case of this reinforcement member 25, even when the lid inclined surface 30b on the front end surface of the back lid 23 is gradually separated from the reinforcement inclined surface 31b on the back surface of the reinforcement member 25 toward the back side of the instrument case 2, the reinforcement inclined surface 31b on the back surface of this reinforcement member 25 in the open state cannot be seen from diagonally above the front side of the instrument case 2, as shown in FIG. 4.

As a result of this structure of the keyboard lid 20, when the front lid 22 and the back lid 23 are arranged side by side in the flat plate shape and close the opening section 2a of the instrument case 2, the lid inclined surface 30a on the back end side of the front lid 22 and the reinforcement inclined surface 31a on the front side of the reinforcement member 25 correspond to and come in close contact with each other and the lid inclined surface 30b on the front end side of the back lid 23 and the reinforcement inclined surface 31b on the back side of the reinforcement member 25 correspond to and come in close contact with each other, whereby the gap between the front lid 22 and the back lid 23 is closed, as shown in FIG. 1, FIG. 3, and FIG. 6.

Also, when the back lid 23 is to be folded with respect to the front lid 22 at the plurality of connection members 24 so that the opening section 2a of the instrument case 2 is open, the lid inclined surface 30b on the front end side of the back lid 23 is gradually separated from the reinforcement inclined surface 31b on the back side of the reinforcement member 25 toward the back side of the instrument case 2 with the reinforcement inclined surface 31a on the front side of the reinforcement member 25 and the lid inclined surface 30a on the back end side of the front lid 22 being in close contact with each other, and the keyboard lid 20 is housed in this state in the back side of the instrument case 2, as shown in FIG. 4. As a result of this structure of the keyboard lid 20, even when the reinforcement inclined surface 31b on the back surface of the reinforcement member 25 is exposed in the open state, the reinforcement inclined surface 31b cannot be seen from diagonally above the front side of the instrument case 2.

Next, the mechanism of this keyboard instrument is described.

When this keyboard instrument is to be played, the keyboard lid 20 is opened so that the keyboard unit 1 is exposed upward. Here, the front end of the front lid 22 is lifted and the front lid 22 is moved backward. As a result, the front guide shafts 22a of the front lid 22 and the back guide shafts 23a of the back lid 23 are moved backward along the guide rail sections 26.

Accordingly, the back lid 23 is gradually folded with respect to the front lid 22, at the connection members 24. In addition, by the guide arm sections (not shown in the drawings), the arm connection sections 23c on the back end portions of the back lid 23 are rotated in the clockwise direction, whereby the back lid 23 is moved toward the lower side of the back part of the keyboard unit 1.

Here, the front lid 22 is moved toward the back side of the instrument case 2, and the back part of the back lid 23 is moved toward the lower side of the back part of the keyboard unit 1. In this movement, the front end surface of the back lid 23 is gradually separated from the back surface of the reinforcement member 25 between the front lid 22 and the back lid 23 with the front surface of the reinforcement member 25 being in close contact with the back end surface of the front lid 22, whereby the back surface of the reinforcement member 25 is exposed toward the back side of the instrument case 2.

That is, since the reinforcement attachment section 25a of the reinforcement member 25 has been attached to the undersurface of the back side of the front lid 22, the lid inclined surface 30b on the front end side of the back lid 23 is gradually separated toward the back side of the instrument case 2 from the reinforcement inclined surface 31b on the back surface of the reinforcement member 25 with the reinforcement inclined surface 31a on the front side of the reinforcement member 25 and the lid inclined surface 30a on the back end side of the front lid 22 being in close contact with each other when the back lid 23 is folded with respect to the front lid 22 at the connection members 24.

Here, the back part of the front lid 22 is moved into the instrument case 2, and the front lid 22 is positioned in the area under the front side top plate 12a of the top plate 12. Accordingly, even when the reinforcement inclined surface 31b on the back side of the reinforcement member 25 is separated from the lid inclined surface 30b on the front end side of the back lid 23 and exposed toward the back side of the instrument case 2, the reinforcement inclined surface 31b on the back side of the reinforcement member 25 attached to and in close contact with the back end surface of the front lid 22 and the lid inclined surface 30b on the front end side of the back lid 23 cannot be seen from diagonally above the front side of the instrument case 2, which enhances the outer appearance and the design.

Then, the front guide shafts 22a of the front lid 22 are arranged at the portions of the guide rail sections 26 located under the front end portion of front side top plate 12a of the top plate 12, and the back guide shafts 23a of the back lid 23 are arranged at the back end portions of the guide rail sections 26 located under the back end portion of the front side top plate 12a of the top plate 12, that is, under the front end portion of the back side top plate 12b of the top plate 12. In addition, the arm connection sections 23c provided on the back end portions of the back lid 23 are arranged behind the lower part of the keyboard unit 1.

As a result, the front lid 22 is arranged under and in substantially parallel with the top plate 12, and the back lid 23 is folded with respect to the front lid 22 at the connection members 24 and hangs down near the back end of the keyboard unit 1. Consequently, the keyboard unit 1 is exposed upward and whereby the plurality of keys 15 is exposed upward so that a musical performance can be started. When a musical performance is started by the plurality of keys 15 of the keyboard unit 1 being subjected to a key depression operation, a musical sound corresponding to the key depression operation is generated from a loudspeaker (not shown in the drawings) and favorably emitted to the outside of the instrument case 2.

On the other hand, when no musical performance is to be performed, the keyboard lid 20 is closed covering the keyboard unit 1. Here, when the front end of the front lid 22 of the keyboard lid 20 is pulled toward the front side of the instrument case 2, the front guide shafts 22a of the front lid 22 and the back guide shafts 23a of the back lid 23 are moved frontward along the guide rail sections 26. Accordingly, by the guide arm sections (not shown in the drawings), the arm connection sections 23c on the back end portions of the back lid 23 are rotated in the counterclockwise direction.

Here, the folded state of the front lid 22 and the back lid 23 by the connection members 24 is gradually released, and the arm connection sections 23c on the back end portions of the back lid 23 are lifted to be at a substantially same height as the guide rail sections 26 by the guide arm sections (not shown in the drawings).

Then, when the front guide shafts 22a of the front lid 22 are arranged in the front end portions of the guide rail sections 26 located above the front plate 9 of the instrument case 2, and the back guide shafts 23a of the back lid 23 are arranged in the portions of the guide rail sections 26 corresponding to a substantially middle portion of the keyboard unit 1 in the front-back direction such that the arm connection sections 23c provided on the back end portions of the back lid 23 are arranged at a substantially same height as the guide rail sections 26, the front lid 22 and the back lid 23 are arranged side by side in the flat plate shape. As a result, by the front lid 22 and the back lid 23, the keyboard unit 1 is covered and the opening section 2a of the instrument case 2 is closed.

Here, only the upper surface of the reinforcement member 25 provided between the front lid 22 and the back lid 23 is exposed to the outside of the instrument case 2. That is, since the front lid 22 and the back lid 23 are arranged side by side in the flat plate shape, the lid inclined surface 30a on the back end side of the front lid 22 and the reinforcement inclined surface 31a on the front side of the reinforcement member 25 come in close contact with each other, and the lid inclined surface 30b of the front end portion of the back lid 23 and the reinforcement inclined surface 31b on the back side of the reinforcement member 25 come in close contact with each other. As a result, the gap between the front lid 22 and the back lid 23 is closed by the reinforcement member 25. In addition, even when a load is applied to the front lid 22 and the back lid 23, this load applied to the front lid 22 and the back lid 23 is reliably received by the reinforcement inclined surfaces 31a and 31b of the reinforcement member 25, whereby the front lid 22 and the back lid 23 are maintained in the flat plate shape.

In this state, since the reinforcement member 25 has been arranged across the entire area between the front lid 22 and the back lid 23, the entire area of the gap between the front lid 22 and the back lid 23 has been favorably covered by this reinforcement member 25. In addition, by the connection members 24 being covered by this reinforcement member 25 decorated in the color of gold, silver, or the like, the decoration design is enhanced and the strength between the front lid 22 and the back lid 23 is ensured. That is, the outer appearance and design of the keyboard lid 20 is enhanced by this reinforcement member 25.

As described above, the keyboard lid 20 of this keyboard instrument includes the front lid 22 which is a first member that is arranged in the front side of the opening section 2a of the instrument case 2 in a manner to be movable in the front and back directions of the instrument case 2, the back lid 23 which is a second member that is arranged in the back side of the opening section 2a of the instrument case 2 in a manner to be movable in the front and back directions, the connection members 24 which foldably connect the front lid 22 and the back lid 23 with each other, and the inelastic reinforcement member 25 arranged between the front lid 22 and the back lid 23. As a result of this structure, the strength is ensured.

More specifically, in the case of the keyboard lid 20 of this keyboard instrument, since the reinforcement member 25 is arranged between the front lid 22 and the back lid 23, the gap between the front lid 22 and the back lid 23 is favorably closed, and the plurality of connection members 24 is favorably covered. In addition, by the reinforcement member 25, the strength between the front lid 22 and the back lid 23 is ensured.

In the case of the keyboard lid 20 of this keyboard instrument, the decorated reinforcement member 25 covers the plurality of connection members 24. As a result of this structure, by the reinforcement member 25, the entire decoration of the keyboard lid 20 is enhanced, and the outer appearance and design of the entire keyboard lid 20 is enhanced. In addition, when arranged between the front lid 22 and the back lid 23, the reinforcement member 25 accents the entire keyboard lid 20. By this accent as well, the outer appearance and design of the entire keyboard lid 20 is enhanced.

Also, in the case of the keyboard lid 20 of this keyboard instrument, since the reinforcement member 25 is arranged across the entire area between the front lid 22 which is a first member and the back lid 23 which is a second member, the entire gap between the front lid 22 and the back lid 23 is reliably and favorably closed and the plurality of connection members 24 is reliably and favorably covered by the reinforcement member 25. In addition, by the color of the reinforcement member 25, the decoration is enhanced. Moreover, by this reinforcement member 25, the strength between the front lid 22 and the back lid 23 is ensured.

Also, in the case of the keyboard lid 20 of this keyboard instrument, the reinforcement member 25 includes the reinforcement attachment section 25a that is an attachment section to be attached to a portion of the front lid 22 of the front and back lids 22 and 23 which does not include portions corresponding to the connection members 24. Accordingly, the reinforcement member 25 can be attached to the front lid 22 by the reinforcement attachment section 25a while being arranged between the front lid 22 and the back lid 23. As a result of this structure, the reinforcement member 25 is reliably and favorably fixed on the front lid 22.

In the present embodiment, in the keyboard lid 20 of the keyboard instrument, the reinforcement attachment section 25a which is an attachment section for the reinforcement member 25 is attached to the undersurface of the front lid 22 that is arranged on the front side of the opening section 2a of the instrument case 2. Accordingly, the reinforcement member 25 can be attached to the front lid 22 by the reinforcement attachment section 25a while being arranged between the front lid 22 and the back lid 23. As a result of this structure, the front end surface of the back lid 23 can be gradually separated toward the back side of the instrument case 2 from the back surface of the reinforcement member 25 with the front surface of the reinforcement member 25 being in close contact with the back end surface of the front lid 22.

As such, in the case of the keyboard lid 20 of this keyboard instrument, when the front lid 22 and the back lid 23 are being folded at the connection members 24 while being moved toward the back side of the instrument case 2, the front end surface of the back lid 23 is gradually separated toward the back side of the instrument case 2 from the back surface of the reinforcement member 25. Accordingly, even when separated from each other and exposed, the front end surface of the back lid 23 and the back surface of the reinforcement member 25 cannot be seen from the outside of the instrument case 2, which also enhances the outer appearance and the design.

Also, in the case of the keyboard lid 20 of this keyboard instrument, the back end surface of the front lid 22 and the front end surface of the back lid 23 opposing each other are formed to be the lid inclined surfaces 30a and 30b which are first inclined surfaces inclined such that their upper parts are located closer to the back side of the instrument case 2 than their lower parts, and the front and back surfaces of the reinforcement member 25 are formed to be the reinforcement inclined surfaces 31a and 31b which are second inclined surfaces inclined at angles equal to those of the lid inclined surfaces 30a and 30b of the front and back lids 22 and 23.

By this structure of the keyboard lid 20 of the keyboard instrument, even when a load is applied to the front lid 22 and the back lid 23, this load applied to the front lid 22 and the back lid 23 is reliably received by the reinforcement inclined surfaces 31a and 31b of the reinforcement member 25, whereby the front lid 22 and the back lid 23 are favorably maintained. In addition, by the reinforcement member 25, the gap between the front lid 22 and the back lid 23 is reliably and favorably covered so that the inside of the instrument case 2 cannot be seen through this gap between the front lid 22 and the back lid 23 when the keyboard lid 20 where the front lid 22 and the back lid 23 have been arranged in the flat plate shape is seen from directly above.

That is, in the case of the keyboard lid 20 of this keyboard instrument, when the front lid 22 and the back lid 23 are pulled toward the front side of the instrument case 2 and arranged in the flat plate shape so as to cover the opening section 2a of the instrument case 2, the lid inclined surface 30a on the back end side of the front lid 22 and the reinforcement inclined surface 31a on the front side of the reinforcement member 25 come in close contact with each other, and the lid inclined surface 30b on the front end side of the back lid 23 and the reinforcement inclined surface 31b on the back side of the reinforcement member 25 come in close contact with each other.

As a result of this structure of the keyboard lid 20 of the keyboard instrument, even when a load is applied to the front lid 22 and the back lid 23, this load applied to the front lid 22 and the back lid 23 is reliably received by the reinforcement inclined surfaces 31a and 31b of the reinforcement member 25, whereby the front lid 22 and the back lid 23 are favorably maintained. In addition, by the reinforcement member 25, the gap between the front lid 22 and the back lid 23 is reliably and favorably covered so that the inside of the instrument case 2 cannot be seen through this gap between the front lid 22 and the back lid 23 when the keyboard lid 20 where the front lid 22 and the back lid 23 have been arranged in the flat plate shape is seen from directly above.

Also, in the case of the keyboard lid 20 of this keyboard instrument, when the front lid 22 and the back lid 23 are being moved toward the back side of the instrument case 2 by the back lid 23 being gradually folded with respect to the front lid 22 at the connection members 24 so as to expose the opening section 2a of the instrument case 2, the front end surface of the back lid 23 is separated toward the back side of the instrument case 2 from the back surface of the reinforcement member 25. As a result of this structure, the front end surface of the back lid 23 can be moved away from the back surface of the reinforcement member 25 toward the back side of the instrument case 2.

That is, in the case of the keyboard lid 20 of this keyboard instrument, since the reinforcement attachment section 25a of the reinforcement member 25 is attached to the undersurface of the back end portion of the front lid 22, the lid inclined surface 30b on the front end side of the back lid 23 can be gradually separated toward the back side of the instrument case 2 from the reinforcement inclined surface 31b on the back side of the reinforcement member 25 with the reinforcement inclined surface 31a on the front side of the reinforcement member 25 and the lid inclined surface 30a on the back end side of the front lid 22 being in close contact with each other when the back lid 23 is folded with respect to the front lid 22 at the connection members 24.

Accordingly, in the case of the keyboard lid 20 of this keyboard instrument, although the reinforcement inclined surface 31b on the back side of the reinforcement member 25 is separated from the lid inclined surface 30b on the front end side of the back lid 23 and exposed when the front lid 22 and the back lid 23 are moved toward the back side of the instrument case 2 by the back lid 23 being folded with respect to the front lid 22 at the connection members 24, the exposed inclined surface 31b of the reinforcement member 25 is not seen from the outside of the instrument case 2 since this exposed inclined surface 31b has been directed toward the back side of the instrument case 2, which also enhances outer appearance and the design.

Also, in the case of the keyboard lid 20 of this keyboard instrument, the cross-sectional shape of the reinforcement member 25 is a substantially parallelogram. Accordingly, when the front lid 22 and the back lid 23 close the opening section 2a of the instrument case 2, the lid inclined surface 30a on the back end surface of the front lid 22 and the reinforcement inclined surface 31a on the front surface of the reinforcement member 25 come in close contact with each other, and the lid inclined surface 30b on the front end surface of the back lid 23 and the reinforcement inclined surface 31b on the back surface of the reinforcement member 25 come in close contact with each other. By this structure as well, loads applied to the front lid 22 and the back lid 23 are unfailingly received by the reinforcement inclined surfaces 31a and 31b of the reinforcement member 25, and the front lid 22 and the back lid 23 are favorably held by the reinforcement inclined surfaces 31a and 31b of the reinforcement member 25.

Moreover, in the case of the keyboard lid 20 of this keyboard instrument, when the front lid 22 and the back lid 23 are arranged side by side in the flat plate shape, the opening section 2a of the instrument case 2 is closed. In addition, when the back lid 23 is folded with respect to the front lid 22 at the connection members 24, the opening section 2a of the instrument case 2 is opened. As a result of this structure, by the front lid 22 and the back lid 23, the opening section 2a of the instrument case 2 is reliably and favorably closed, and smoothly and favorably opened.

In the above-described embodiment, the reinforcement member 25 includes the reinforcement attachment section 25a that is attached to the undersurface of the front lid 22. However, the present disclosure is not limited thereto. For example, a structure may be adopted in which the reinforcement member 25 includes a reinforcement attachment section that is attached to the undersurface of the back lid 23.

Also, in the above-described embodiment, the back end surface of the front lid 22 and the front end surface of the back lid 23, which are the opposing surfaces of the front lid 22 and the back lid 23, are formed to be the lid inclined surfaces 30a and 30b inclined such that their upper parts are located closer to the back side of the instrument case 2 than their lower parts, and the front and back surfaces of the reinforcement member 25 are formed to be the reinforcement inclined surfaces 31a and 31b inclined at angles equal to those of the lid inclined surfaces 30a and 30b. However, the present disclosure is not limited thereto, and these surfaces may be inclined in the opposite directions.

More specifically, a structure may be adopted in which the back end surface of the front lid 22 and the front end surface of the back lid 23 opposing each other are formed to be lid inclined surfaces inclined such that their upper parts are located closer to the front side of the instrument case 2 than their lower parts, and the front and back surfaces of the reinforcement member 25 are formed to be reinforcement inclined surfaces inclined at angles equal to those of the lid inclined surfaces. Also, the back end surface of the front lid 22 and the front end surface of the back lid 23 are not necessarily required to be inclined surfaces and may be vertical surfaces.

Also, in the above-described embodiment, the present disclosure has been applied in a keyboard instrument. However, the present disclosure is not limited thereto. For example, the present disclosure may be applied in electronic devices such as audio devices.

While the present invention has been described with reference to the preferred embodiments, it is intended that the invention be not limited by any of the details of the description therein but includes all the embodiments which fall within the scope of the appended claims.

What is claimed is:

1. A lid member comprising:
a first member which is arranged on a front side of an opening portion of a case in a manner to be movable in front and back directions of the case;
a second member which is arranged on a back side of the opening portion of the case in a manner to be movable in the front and back directions;
a connection member which foldably connects the front member and the second member with each other; and
an inelastic reinforcement member which is arranged between the front member and the second member.

2. The lid member according to claim 1, wherein the reinforcement member is decorative and covers the connection member.

3. The lid member according to claim 1, wherein the reinforcement member is arranged across an entire area between the first member and the second member.

4. The lid member according to claim 1, wherein the reinforcement member includes an attachment portion which is attached to an area that is on the first member or the second member and does not include a portion corresponding to the connection member.

5. The lid member according to claim 4, wherein the attachment portion of the reinforcement member is attached to an undersurface of the first member which is arranged on the front side of the opening portion of the case.

6. The lid member according to claim 1, wherein a back end surface of the first member and a front end surface of the second member opposing each other are formed to be first inclined surfaces, and
wherein front and back surfaces of the reinforcement member are formed to be second inclined surfaces inclined at angles equal to angles of the first inclined surfaces of the first member and the second member.

7. The lid member according to claim 1, wherein a cross-sectional shape of the reinforcement member is a substantially parallelogram.

8. The lid member according to claim 1, wherein the first member and the second member close the opening portion of the case when arranged side by side in a flat plate shape, and expose the opening portion of the case when the second member is folded with respect to the first member at the connection member.

9. The lid member according to claim 1,
wherein front guide shafts are provided on right and left sides of a front end portion of the first member,
wherein back guide shafts are provided on right and left sides of a front end portion of the second member,
wherein a plurality of arm connection sections are provided on a back end portion of the second member.

10. The lid member according to claim 8,
wherein front guide shafts are provided on right and left sides of a front end portion of the first member,
wherein back guide shafts are provided on right and left sides of a front end portion of the second member,
wherein a plurality of arm connection sections are provided on a back end portion of the second member.

11. The lid member according to claim 10, wherein the arm connection sections are vertically rotated when the first member and the second member open or close the opening portion of the case.

12. A keyboard instrument comprising the lid member according to claim 1.
